(19) United States
(12) Patent Application Publication
(10) Pub. No.: US 2007/0046607 A1
(43) Pub. Date: Mar. 1, 2007

(54) Display panels

(75) Inventor: Ming-Sheng Lai, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/268,874

(22) Filed: Nov. 8, 2005

(30) Foreign Application Priority Data
Aug. 24, 2005 (TW) 94128926

(51) Int. Cl. G09G 3/36

(52) U.S. Cl. 345/92

(57) ABSTRACT

A display panel, comprising a scan driver, at least one data driver, and a plurality of pixel groups. The scan driver drives a plurality of scan lines arranged in a first direction. The data driver drives a plurality of data lines arranged in a second direction. Each pixel group comprises a predetermined number of pixels arranged in the second direction. In each pixel group, the pixels are coupled to the same scan line and simultaneously receive video signals.

This application claims the benefit of Taiwan application Serial No. 94128926 filed Aug. 24, 2005, the subject matter of which is incorporated herein by reference.

### BACKGROUND

The invention relates to a display panel, and in particular to a pixel array in which pixels in rows are turned on and receives video signals, simultaneously.

FIG. 1 is a schematic diagram of a display array of a conventional liquid crystal display (LCD) panel. As shown in FIG. 1, a display panel 1 comprises a data driver 10, a scan driver 11, and a display array 12. The data driver 10 drives a plurality of data lines D₁ to D_{Y} arranged in a column direction. The scan driver 11 drives a plurality of scan lines S₁ to S_{X} in a row direction. The display array 12 of Y columns and X rows is formed by the interlaced data lines D₁ to D_{Y} and scan lines S₁ to S_{X}, and each interlaced data line and scan line controls one pixel. For example, interlaced data line D₁ and scan line S₁ control a pixel 100. As with any other pixel, the equivalent circuit of the pixel 100 comprises a switch transistor T10, a storage capacitor Cs10, and a liquid crystal capacitor Clc10.

The scan driver 11 sequentially outputs scan signals to the scan lines S₁ to S_{X} according to a scan control signal. When receiving a scan signal, a scan line corresponding to a row turns on the switch transistors within all pixels corresponding to the row, while the switch transistors within all pixels corresponding to all other rows are turned off by other scan lines. When the switch transistors within all display unit pixels corresponding to a row are all turned on, the data driver 10 outputs corresponding video signals with gray scale values to pixels corresponding to the row through the data lines D₁ to D_{Y} according to image data prepared for but not yet displayed. Each time the scan driver 11 finishes scanning the scan lines S₁ to S_{X}, the operation to display a single frame is completed. Therefore, the object of displaying images is achieved by repeatedly scanning the scan lines S₁ to S_{X} and outputting the video signals.

For a display system with a 60 Hz frame frequency, a single frame is updated every 16.7 seconds. When the frame time is fixed, the time for scanning each scan line is equal to the time for charging each pixel. With the increased resolution of the LCD panel, the time for scanning each scan line is decreased, resulting the decreased time for charging each pixel. Moreover, in some conventional LCD panels, an additional black picture frame is inserted between two frames, such that the time required for charging each pixel can be also decreased, and the charging operation is insufficient for each pixel.

### SUMMARY

An exemplary embodiment of a display panel, comprises a scan driver, at least one data driver, and a plurality of pixel groups. The scan driver drives a plurality of scan lines arranged in a first direction. The data driver drives a plurality of data lines arranged in a second direction. Each pixel group comprises a predetermined number of pixels arranged in the second direction. In each pixel group, the pixels are coupled to the same scan line and simultaneously receive video signals.

In some embodiments, when the display panel comprises only one data driver, the pixels are coupled to the data driver through different data lines in one pixel group. The data driver simultaneously outputs video signals to the pixels in one pixel group through respective data lines.

In some embodiments, when the display panel comprises more than one data driver, the pixels are coupled to different data drivers through different data lines in one pixel group. The data drivers simultaneously output video signals to the pixels in one pixel group through respective data lines.

### DESCRIPTION OF THE DRAWINGS

The invention will become more fully understood from the detailed description given hereinbelow and the accompanying drawings, given by way of illustration only and thus not intended to be limitative of the invention.

FIG. 1 shows a conventional LCD panel.

FIG. 2 depicts an exemplary embodiment of a display panel.

FIG. 3 show sub-scan lines in the display panel in FIG. 2.

FIG. 4 depicts an exemplary embodiment of a display panel.

FIG. 5 show sub-scan lines in the display panel in FIG. 4.

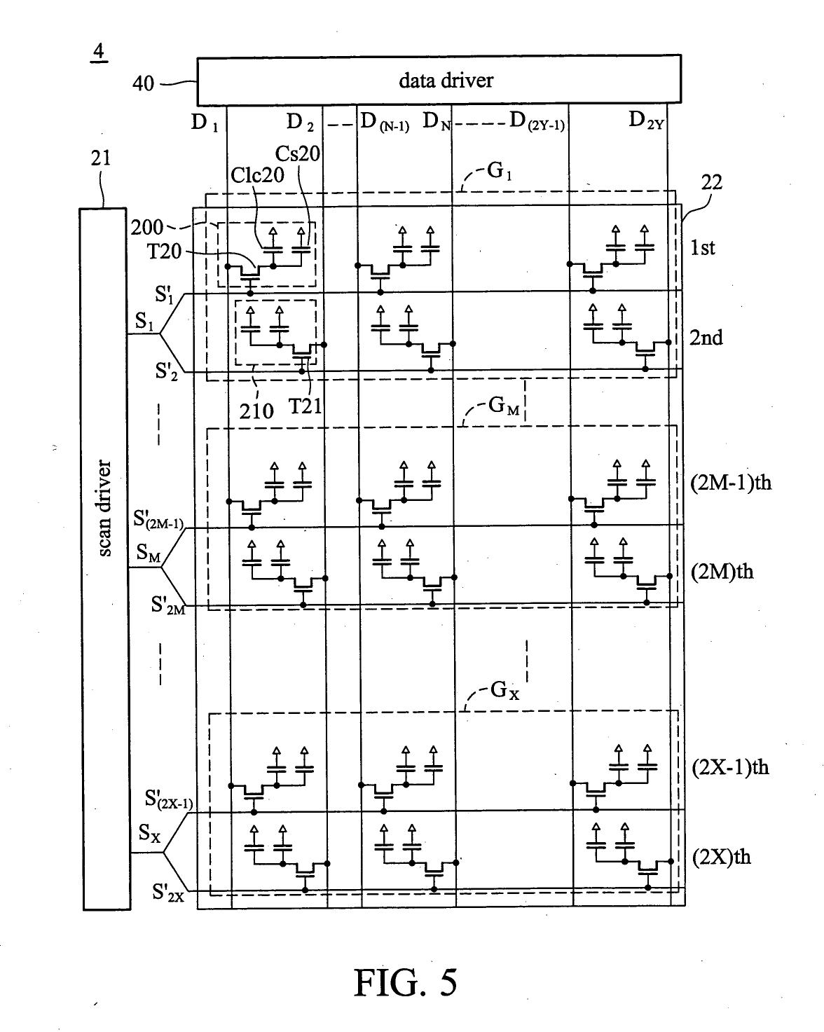

### DETAILED DESCRIPTION

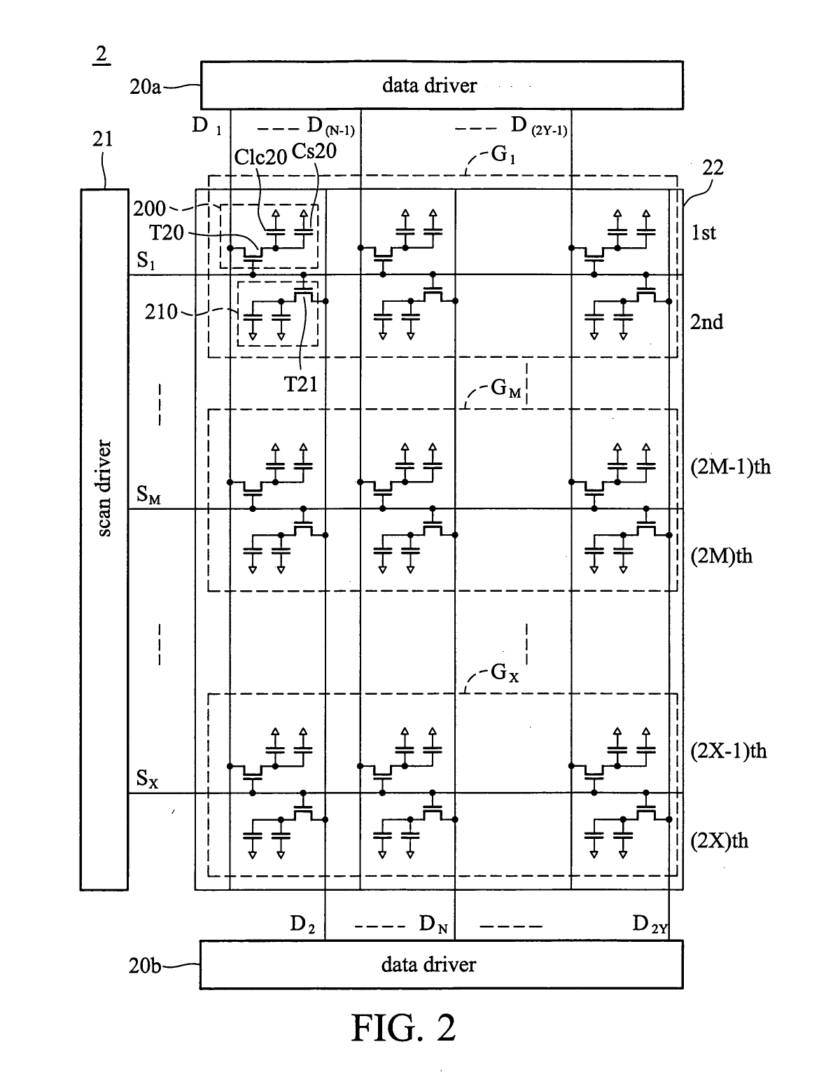

In an exemplary embodiment of a display panel, as shown in FIG. 2, a display panel 2 comprises data drivers 20a and 20b, a scan driver 21, and a pixel array 22. The data driver 20a drives a plurality of data lines D₁ to D_{(2Y-1)} arranged in a column direction, while the data driver 20b drives a plurality of data lines D₂ to D_{2Y} arranged in the column direction, wherein Y is a natural number. The data lines D₁ to D_{(2Y-1)} and D₂ to D_{2Y} are parallel. The scan driver 21 sequentially drives a plurality of scan lines S₁ to S_{X} arranged in a row direction, and the scan lines S₁ to S_{X} are parallel, wherein X is a natural number. The data lines D₁ to D_{(2Y-1)} and D₂ to D_{2Y} are interlaced with the scan lines S₁ to S_{X} to define the pixel array 22. Each interlaced data line and scan line defines a pixel, for example the interlaced data line D₁ and the scan line S₁ define a pixel 200. Referring to FIG. 2, as with any other pixel, the equivalent circuit of the pixel 200 comprises a switch transistor T20, a storage capacitor Cs20, and a liquid crystal capacitor Clc20. The switch transistor T20 can be a thin film transistor (TFT).

Referring to FIG. 2, the pixels of the pixel array 22 are disposed in a matrix configuration with 2× (rows)×Y (columns). The switch transistors of the pixels in the (2M-1)th row are coupled to the data driver 20a through the data lines D₁ to D_{(2Y-1)}, while the switch transistors of the pixels in the 2Mth row are coupled to the data driver 20b through the data lines D₂ to D_{2Y}, wherein 1≦M≦X. In the same column, the switch transistor of the pixel in the (2M-1)th row and the switch transistor of the pixel in the 2Mth row are respectively coupled to the data lines D_{(N-1)} and D_{N}, wherein 2≦N≦2Y. For example, if M=1 and N=2, the switch transistor T20 of the pixel 200 in the 1st row is coupled to the data driver 20a through the first data line D₁, and the switch transistor T21 of the pixel 210, being adjacent to the pixel 200, in the 2nd row is coupled to the data driver 20b through the second data line D₂.

According to the configuration between the scan driver 21 and the pixels of FIG. 2, the pixels in every two rows are classified into one pixel group and coupled to the scan driver 21 through the same scan line. For example, the pixels in the 1st and 2nd rows are classified into a pixel group G₁ and coupled to the scan driver 21 through the first scan line S₁; the pixels in the 3rd and 4th rows are classified into a pixel group G₂ and coupled to the scan driver 21 through the second scan line S₂; and the pixels in the (2M-1)th and 2Mth rows are classified into a pixel group GM and coupled to the scan driver 21 through the Mth scan line SM. In other words, in one pixel group, all pixels are coupled to the same scan line and the pixels in the same column are coupled to the different data line.

For clarity, the pixels 200 and 210 in the pixel group G₁ are taken as an example, wherein the pixels 200 and 210 are in the same column and respectively in the 1st and 2nd rows. The operation of the other pixels in the 1st row is same as that of the pixel 200, and the operation of the other pixels in the 2nd row are same as that of the pixel 210. The pixel 200 is coupled to the data driver 20a through the first data line D₁ and to the scan driver 21 through the first scan line S₁. The pixel 210 is coupled to the data driver 20b through the second data line D₂ and to the scan driver 21 through the first scan line S₁. During a frame, when the scan driver 21 drives the first scan line S₁, the pixel group is turned on, so that the switch transistor T20 of the pixel 200 and the switch transistor T21 of the pixel 210 are turned on. When the switch transistors T20 and T21 are turned on, the data driver 20a outputs a corresponding video signal to the pixel 200 through the first data line D₁, and the data driver 20b outputs a corresponding video signal to the pixel 210 through the second data line D₂. In other words, pixels in one group are turned on and receive respective video signals, simultaneously.

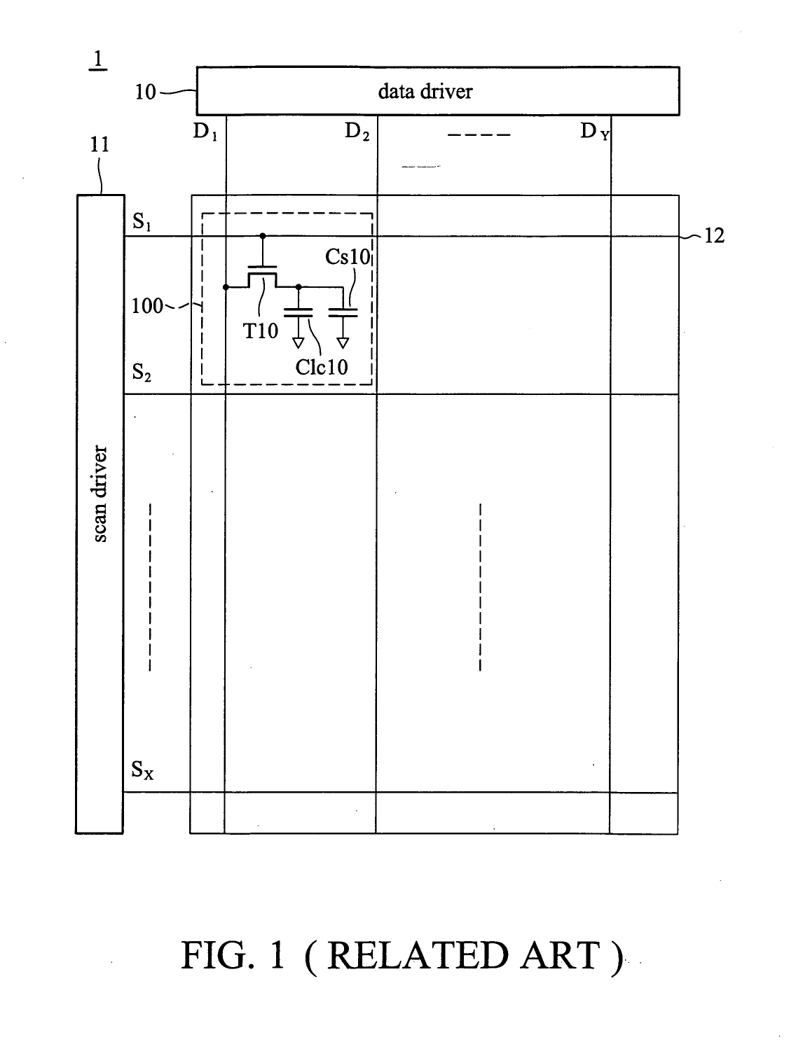

It is assumed that X=540 and Y=1920. According to the display panel 1 of FIG. 1, the pixel array 12 of 540×1920 requires 540 scan lines S₁ to S₅₄₀. According to the embodiment of FIG. 2, a pixel array of 540 (2X)×1920 (Y) requires 270 scan lines S₁ to S₂₇₀. The number of scan lines of FIG. 2 is less than the number of scan lines of FIG. 1. Thus, for completing a single frame, the time required by the scan driver 21 to scanning all the scan lines is a half of the time required by the scan driver 11 to scan all the scan lines, avoiding the problem in insufficient charge for the pixels.

According to the embodiment of FIG. 2, 2Y data lines are driven by two data drivers. Thus, pixels in two rows are classified into one pixel group, and each group is controlled by one scan line. In one pixel group, the pixels in the (2M-1)th row are coupled to the data driver 20a through the data lines D₁ to D_{(2Y-1)}, and the pixels in the 2Mth row are coupled to the data driver 20b through the data lines D₂ to D_{2Y}. In other words, the two pixels in the same column are coupled to different data drivers through the respective data lines.

According to the embodiment of FIG. 2, when pixels in three or more than three rows are classified into one pixel group, the number of data lines is equal to ZY, wherein 3≦Z≦X. In one pixel group, switch transistors of Z pixels in the same column are coupled to the different data drivers through respective data lines. In other words, when pixels in every Z rows are classified into one pixel group and every pixel group is controlled by a scan line, ZY data lines are required. Thus, a pixel array is defined by the pixels with ZX (rows)×Y (columns). When one scan line is driven, the pixels in Z rows simultaneously receive video signals. To complete a single frame, the time required by a scan driver to scan all scan lines is equal to 1/Z of the time required by the scan driver 11 of FIG. 1 to scanning all the scan lines.

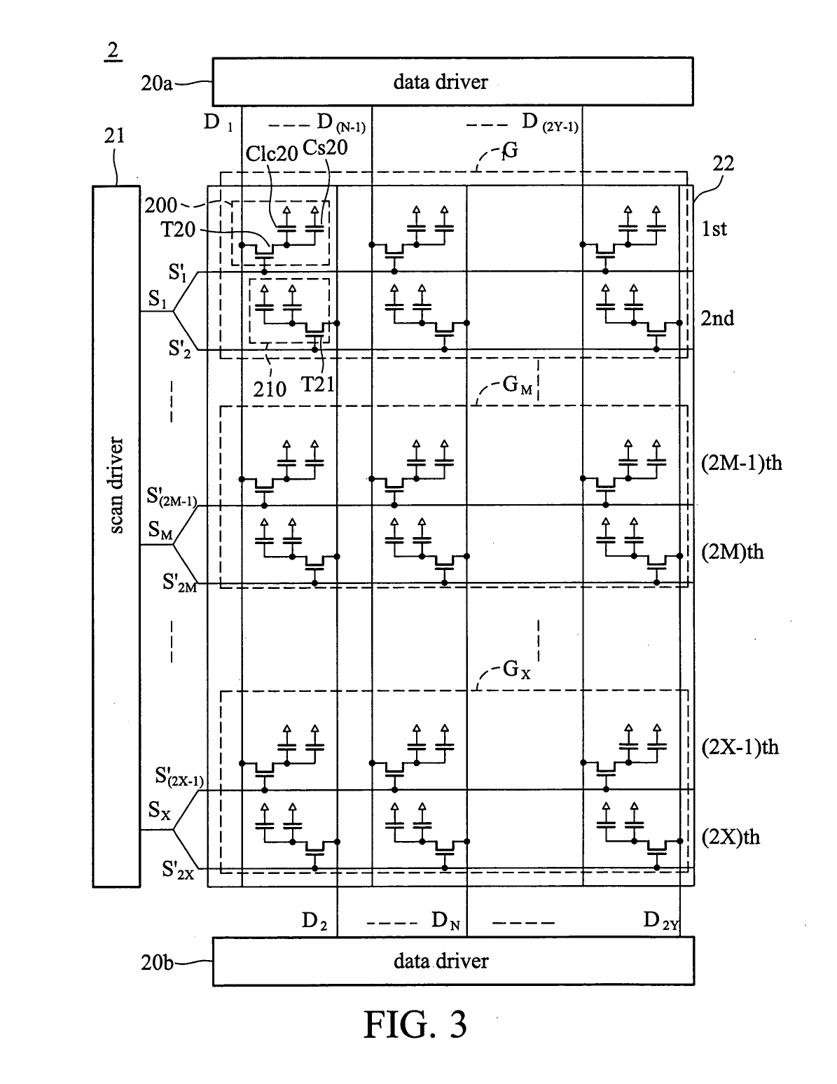

In FIG. 3, switch transistors of pixels in one pixel group are coupled to the same sane line, for example, the switch transistors of the pixels in the pixel group G₁ are coupled to the scan line S₁. The connections between the pixels in one group and the corresponding scan line are completed by sub-scan lines, as shown in FIG. 3. In the pixel group G₁, the switch transistors of the pixels in the 1st row are coupled to a sub-scan line S′₁, the switch transistors of the pixels in the 2nd row are coupled to a sub-scan line S′₂, and the sub-scan lines S′₁ and S′₂ are connected to the scan line S₁ together. That is the pixels on the 1st and 2nd rows are coupled to the scan line S₁ through respective sub-scan lines. In other words, the switch transistors of the pixels in the (2M-1)th row are coupled to a sub-scan line S′_{(2M-1)}, the switch transistors of the pixels in the 2Mth row are coupled to a sub-scan line S′_{2M}, and the sub-scan lines S′_{(2M-1)} and S′_{2M} are connected to the scan line S_{M} together. Thus, in one pixel group, the pixels in each row can couple to the corresponding scan line through the respective sub-scan lines.

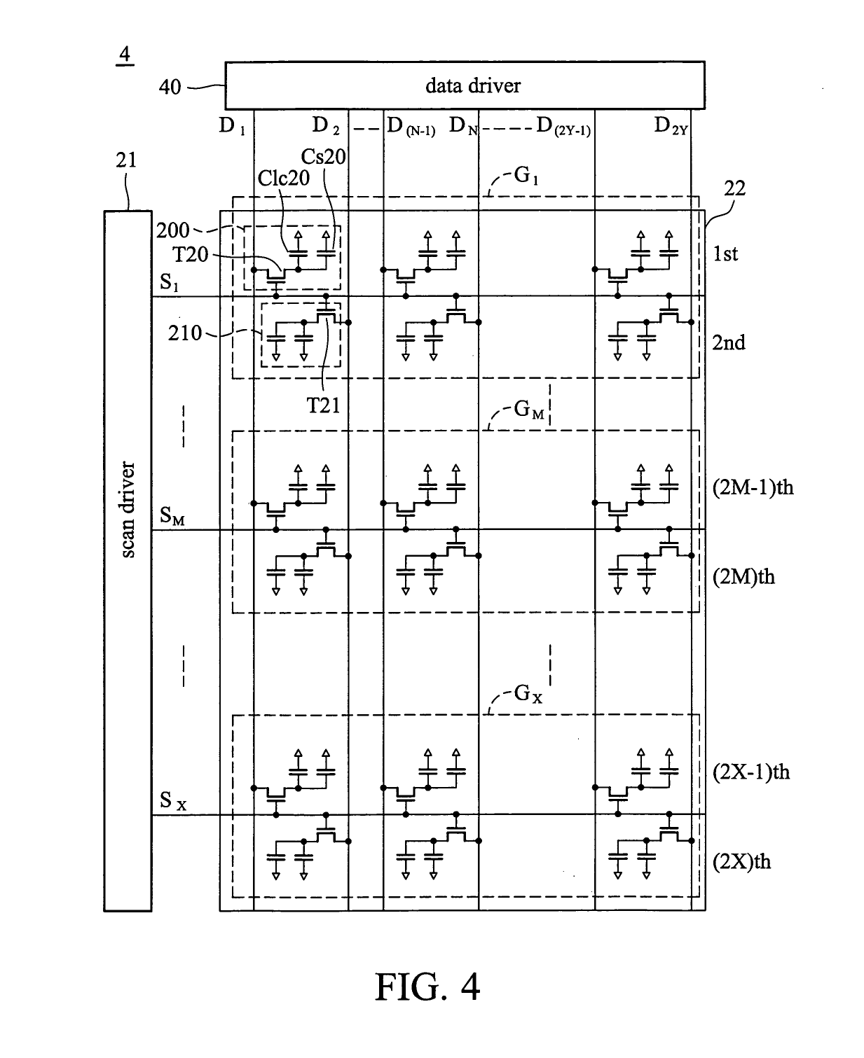

In an exemplary embodiment of a display panel, as shown in FIG. 4, a display panel 4 comprises some of the same elements as the elements of the display panel 2 in FIG. 2, and these same elements are represented by the same labels. Referring to FIGS. 2 and 4, the difference between the display panels 2 and 4 are the number of data drivers and the connection between the data driver and the pixels. Referring to FIG. 2, the switch transistors of the pixels in the (2M-1)th row are coupled to the data driver 20a through the data lines D₁ to D_{(2Y-1)}, while the switch transistors of the pixels in the 2Mth row are coupled to the data driver 20b through the data lines D₂ to D_{2Y}. Referring to FIG. 4, the display panel 4 comprises only one data driver 40, the pixels in the (2M-1)th and 2Mth rows are coupled to the data driver 40 through the respective data lines. The switch transistors of the pixels in the (2M-1)th row are coupled to the data driver 40 through the data lines D₁ to D_{(2Y-1)}, and the switch transistors of the pixels in the 2Mth row are coupled to the data driver 40 through the data lines D₂ to D_{2Y}, wherein 1≦M≦X. In the same column, the switch transistor of the pixel in the (2M-1)th row and the switch transistor of the pixel in the 2Mth row are respectively coupled to the data lines D_{(N-1)} and D_{N}, wherein 2≦N≦2Y. For example, in the pixel group G₁, if M=1 and N=2, the switch transistor T20 of the pixel 100 in the 1st row is coupled to the data driver 40 through the first data line D₁, and the switch transistor T21 of the pixel 210 in the 2nd row is coupled to the data driver 40 through the second data line D₂.

The pixel group G₁ is taken as an example, and it is assumed M is equal to 1. During a frame, the scan driver 21 turns on all pixels in the pixel group G₁ through the first scan line S₁. When the pixels in the pixel group G₁ are turned on, the data driver 40 simultaneously outputs video signals to the pixels in the pixel group G₁ through the data line D₁ to D_{(2Y-1)} and D₂ to D_{2Y}. In other words the pixels in the pixel group G₁ are turned on and receive the video signals, simultaneously. It is noted that one data driver is used to output video signals to the pixels in one pixel group according the embodiment of FIG. 2, while two data drivers are used to output video signals to the pixels in two rows in one pixel group according the embodiment of FIG. 4.

According to the embodiment of FIG. 4, when pixels in three or more than three rows are classified into one pixel group, the number of data lines is equal to ZY, wherein 3≦Z≦X. In one pixel group, switch transistors of Z pixels in the same column are coupled to the same data drivers through respective data lines. In other words, when pixels in every Z rows are classified into one pixel group and every pixel group is controlled by a scan line, ZY data lines are required. Thus, a pixel array is defined by the pixels with ZX (rows)×Y (columns).

The connections between the pixels in one group and the corresponding scan line are completed by sub-scan lines, as shown in FIG. 35. In the pixel group G₁, the switch transistors of the pixels in the 1st row are coupled to a sub-scan line S′₁, the switch transistors of the pixels in the 2nd row are coupled to a sub-scan line S′₂, and the sub-scan lines S′₁ and S′₂ are connected to the scan line S₁ together. That is the pixels on the 1st and 2^{nd} rows are coupled to the scan line S₁ through respective sub-scan lines. In other words, the switch transistors of the pixels in the (2M-1)th row are coupled to a sub-sane line S′_{(2M-1)}, the switch transistors of the pixels in the 2Mth row are coupled to a sub-scan line S′_{2M}, and the sub-scan lines S′_{(2M-1)} and S′_{2M} are connected to the scan line S_{M} together. Thus, in one pixel group, the pixels in each row can coupled to the corresponding scan line through the respective sub-scan lines.

According to the embodiment of FIG. 4, the number of rows in one pixels group can be determined according to system requirements. Moreover, it is worth noting that only one data driver is used to output video signals to all pixels.

While the invention has been described in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A display panel, comprising:
X scan lines arranged in parallel and in a first direction, wherein X is a natural number; and
2Y data lines arranged in parallel and in a second direction and interlaced with the scan lines to define a pixel array comprising pixels in 2X rows and Y columns, wherein each pixel is defined by the interlaced data and scan lines and comprises a thin film transistor (TFT), and Y is a natural number; and
wherein in the same column, a first TFT of the pixel in the (2M-1)th row and a second TFT of the pixel in the 2Mth row are coupled to the Mth scan line, and 1≦M≦X; and
wherein, the first and second TFTs are respectively coupled to the (N-1)th and Nth data lines, and 2≦N≦2Y.

2. The display panel as claimed in claim 1, wherein the scan lines are driven by a scan driver.

3. The display panel as claimed in claim 2, wherein the data lines are driven by a data driver.

4. The display panel as claimed in claim 2, wherein the (N-1)th data line in driven by a first data driver, and the Nth data line is driven by a second driver.

5. A display panel, comprising:
X scan lines, wherein X is a natural number;
2X sub-scan lines arranged in parallel and in a first direction, wherein each scan line is coupled to the (2M-1)th sub-scan line and the 2Mth sub-scan line and
2Y data lines arranged in parallel and in a second direction and interlaced with the sub-scan lines to define a pixel array comprising pixels in 2X rows and Y columns, wherein each pixel is defined by the interlaced data and sub-scan lines and comprises a thin film transistor (TFT), and Y is a natural number; and
wherein in the same column, a first TFT of the pixel in the (2M-1)th row and a second TFT of the pixel in the 2Mth row are coupled to the Mth scan line, and 1≦M≦X; and
wherein, the first and second TFTs are respectively coupled to the (N-1)th and Nth data lines, and 2≦N≦2Y.

6. The display panel as claimed in claim 5, wherein the scan lines are driven by a scan driver.

7. The display panel as claimed in claim 6, wherein the data lines are driven by a data driver.

8. The display panel as claimed in claim 6, wherein the (N-1)th data line in driven by a first data driver, and the Nth data line is driven by a second driver.

9. A display panel, comprising:
a scan driver;
a data driver;
X scan lines driven by the scan driver and arranged in parallel and in a first direction, wherein X is a natural number; and
2Y data lines driven by the data driver, arranged in parallel and in a second direction, and interlaced with the scan lines to define a pixel array comprising pixels in 2X rows and Y columns, wherein each pixel is defined by the interlaced data and scan lines and comprises a thin film transistor (TFT), and Y is a natural number; and
wherein in the same column, a first TFT of the pixel in the (2M-1)th row and a second TFT of the pixel in the 2Mth row are coupled to the Mth scan line, and 1≦M≦X; and
wherein, the first and second TFTs are respectively coupled to the (N-1)th and Nth data lines, and 2≦N≦2Y.

10. A display panel, comprising:
a scan driver;
first and second data drivers;
X scan lines driven by the scan driver and arranged in parallel and in a first direction, wherein X is a natural number; and
2Y data lines driven by the first and second data drivers and arranged in parallel and in a second direction, wherein the (N-1) data line is driven by the first data driver, the Nth data line is driven by the second data driver, and Y is a natural number; and
wherein the data lines are interlaced with the scan lines to define a pixel array comprising pixels in 2X rows and Y columns, each pixel is defined by the interlaced data and scan lines and comprises a thin film transistor (TFT);
wherein in the same column, a first TFT of the pixel in the (2M-1)th row and a second TFT of the pixel in the 2Mth row are coupled to the Mth scan line, and 1≦M≦X; and
wherein, the first and second TFTs are respectively coupled to the (N-1)th and Nth data lines, and 2≦N≦2Y.

11. A display panel, comprising:
a scan driver;
a data driver;
X scan lines driven by the scan driver, wherein X is a natural number;
2X sub-scan lines arranged in parallel and in a first direction, wherein each scan line is coupled to the (2M-1)th sub-scan line and the 2Mth sub-scan line; and
2Y data lines driven by the data driver, arranged in parallel and in a second direction, and interlaced with the sub-scan lines to define a pixel array comprising pixels in 2X rows and Y columns, wherein each pixel is defined by the interlaced data and sub-scan lines and comprises a thin film transistor (TFT), and Y is a natural number; and
wherein in the same column, a first TFT of the pixel in the (2M-1)th row and a second TFT of the pixel in the 2Mth row are coupled to the Mth scan line, and 1≦M≦X; and
wherein, the first and second TFTs are respectively coupled to the (N-1)th and Nth data lines, and 2≦N≦2Y.

12. A display panel, comprising:
a scan driver;
first and second data drivers;
X scan lines driven by the scan driver, wherein X is a natural number;
2X sub-scan lines driven by the data driver, and arranged in parallel and in a first direction, wherein each scan line is coupled to the (2M-1)th sub-scan line and the 2Mth sub-scan line; and
2Y data lines driven by the first and second data drivers and arranged in parallel and in a second direction, wherein the (N-1) data line is driven by the first data driver, the Nth data line is driven by the second data driver, and Y is a natural number;
wherein the data lines are interlaced with the sub-scan lines to define a pixel array comprising pixels in 2X rows and Y columns, each pixel is defined by the interlaced data and sub-scan lines and comprises a thin film transistor (TFT);
wherein in the same column, a first TFT of the pixel in the (2M-1)th row and a second TFT of the pixel in the 2Mth row are coupled to the Mth scan line, and 1≦M≦X; and
wherein, the first and second TFTs are respectively coupled to the (N-1)th and Nth data lines, and 2≦N≦2Y.

13. A display panel, comprising:
X scan lines arranged in parallel and in a first direction, wherein X is a natural number and 3≦Z≦X; and
ZY data lines arranged in parallel and in a second direction and interlaced with the scan lines to define a pixel array comprising pixels in ZX rows and Y columns;
wherein each scan line is coupled to the pixels in the Z rows.

14. The display panel as claimed in claim 13, wherein the scan lines are driven by a scan driver.

15. The display panel as claimed in claim 14, wherein the data lines are driven by a data driver.

16. The display panel as claimed in claim 14, wherein the Zth data line in driven by a first data driver, the (Z-1)th data line in driven by a second data driver, and the (Z-2)th data line is driven by a third data driver.

17. A display panel, comprising:
a scan driver driving a plurality of scan lines arranged in a first direction;
at least one data driver driving a plurality of data lines arranged in a second direction; and
a plurality of pixel groups, each comprising a predetermined number of pixels arranged in the second direction;
wherein in each pixel group, the pixels are coupled to the same scan line and simultaneously receive video signals.

18. The display panel as claimed in claim 17 further comprising a plurality of sub-scan lines coupled to the scan lines, wherein in each pixel group, the pixels are coupled to the same scan line through the different sub-scan lines.
